(19) United States
(12) Patent Application Publication
(10) Pub. No.: US 2012/0077037 A1
(43) Pub. Date: Mar. 29, 2012

(54) METAL COMPLEX NANOPARTICLES AND METHOD FOR PRODUCING THE SAME

(75) Inventors: Tohru KAWAMOTO, Tsukuba-shi (JP); Masato KURIHARA, Tsukuba-shi (JP); Hisashi TANAKA, Tsukuba-shi (JP)

(73) Assignee: NATIONAL INSTITUTE OF ADVANCED INDUSTRIAL SCIENCE AND TECHNOLOGY, Tokyo (JP)

(21) Appl. No.: 13/052,744

(22) Filed: Mar. 21, 2011

(30) Foreign Application Priority Data
Sep. 28, 2010 (JP) 2010-217848

(51) Int. Cl. C01C 3/11; C01C 3/12; C09K 9/00; B32B 5/16

(52) U.S. Cl. 428/402.24; 428/402; 423/364; 423/367; 252/583

(57) ABSTRACT

A method for producing metal complex nanoparticles, the method having: providing an aqueous solution containing a metal cyano complex anion having a metal atom M_{A} as a central metal, with an aqueous solution containing zinc cation, the pH of the aqueous solution containing zinc cation being adjusted; and mixing the solutions and thereby producing metal complex nanoparticles composed of the metal atom M_{A} and zinc under controlling the properties of the obtained metal complex nanoparticles.

### TECHNICAL FIELD

The present invention relates to metal complex nanoparticles that can be suitably used as a material for electrochemical elements and the like, and a method for producing the nanoparticles.

### BACKGROUND ART

A wide variety of studies have been conducted hitherto on metal cyano complexes that are mainly composed of a metal ion and a cyano group. Particularly, extensive research and investigations on practical use have been carried out on Prussian blue and analogues having the crystal structure of Prussian blue (hereinafter, referred to as “Prussian blue-type metal complexes”).

FIG. 6 shows the crystal structure of the Prussian blue-type metal complex. The structure is relatively simple, and is such that two kinds of metal atoms (M_{A} and M_{B}) assembling NaCl-type lattices are three-dimensionally crosslinked with cyano groups. As the metallic atoms, various elements such as vanadium (V), chromium (Cr), molybdenum (Mo), tungsten (W), manganese (Mn), iron (Fe), ruthenium (Ru), cobalt (Co), nickel (Ni), platinum (Pt), copper (Cu) can be used. For example, Patent Literature 1 discloses an example of applying the ones as materials for electrochromic elements, and examples of the complexes include those using iron (Fe), nickel (Ni), and cobalt (Co) as the constituent metal atom. In addition, the composition formula of a Prussian blue type complex can be written as AₓM^{A}[M^{B}(CN)₆]_{y}.zH₂O. Here, A represents a cation, and M^{A} and M^{B} each represent a metal ion.

It has been made clear, then, that a zinc-iron cyano complex in which zinc (Zn) and iron (Fe) are applied to the constituent metal atoms, may be formed in a crystal structure different from the Prussian blue type complex (see Non-Patent Literature 1) (FIG. 7). The characteristic structure formed by this zinc-iron cyano complex is called a Prussian blue-like complex or a crystal thereof, and this structure is explained by distinguishing it from the Prussian blue type complex or a crystal thereof. Since a zinc-iron cyano complex occupies a unique crystal structure as explained above, the complex is expected to exhibit its unique properties. Non-Patent Literature 2 discloses that a zinc-iron cyano complex is applied to an ink having electrochromic properties. The production method employed herein is to mix an acidic iron cyano complex solution with a solution of zinc acetate. However, the particles obtained by this technique are relatively large, such that the length in a long side is 300 nm or more. Furthermore, it is reported that these nanoparticles do not exhibit stable electrochemical characteristics when used only by themselves, but the nanoparticles exhibit stable electrochemical responses when PEDOT:PSS, which is an electrically conductive polymer, is added to the nanoparticles.
{Patent Literature 1} WO 2007/020946 pamphlet
{Non-Patent Literature 1} Lithium Chloride Sorption by Zinc Hexacyanoferrate(II) from a Nonaqueous Medium, T. A. Denisova, L. G. Maksimova, O. N. Leonidova, M, A. Melkozerova, N. A. Zhuravlev, and E. V. Polyakov, Russian Journal of Inorganic Chemistry, 2009, Vol. 54, No. 5, pp. 649-657
{Non-Patent Literature 2} A red-to-gray poly(3-methylthiophene) electrochromic device using a zinc hexacyanoferrate/PEDOT:PSS composite counter electrode, Siang-Fu Honga and Lin-Chi Chen, Electrochimica Acta, Volume 55, Issue 12, 30 April 2010, Pages 3966-3973

### DISCLOSURE OF INVENTION

### Technical Problem

Generally, in regard to electrochemical elements, addition of an optional material may often adversely affect durability and the like of the material, depending on the use or the like. It is preferable to avoid the addition of such an electrically conductive polymer that described in the Non-Patent Literature 2, and besides the material is possibly desired such that can exhibit electrochemical responses even if a metal complex nanoparticle is used alone. Furthermore, in the method for preparing metal complex particles by utilizing dropwise addition as employed in the Non-Patent Literature 2, the aqueous solution concentration of the raw material used should be markedly lowered, to a concentration as low as 10 mM. In order to prepare a high concentration dispersion liquid that is appropriate for industrial use, the dispersion liquid must be first dried and then redispersed. Consequently, there is a problem that a large amount of water is required, and there are also problems with the ability for mass production, and the like.

The present invention addresses to the provision, in connection with nanoparticles of a metal complex containing zinc formed in a particular crystal structure, a method for producing metal complex nanoparticles in high productivity, and the method is capable of obtaining nanoparticles that can exhibit desired properties (particle size, stable electrochemical responsiveness, and the like) even without adding other materials. Further, the present invention addresses to the provision of metal complex nanoparticles imparted with the desired properties, which are obtained by the method.

### Means of Solving the Problems

According to the present invention, there is provided the following means:

(1) A method for producing metal complex nanoparticles, the method comprising: providing an aqueous solution containing a metal cyano complex anion having a metal atom M_{A} as a central metal, with an aqueous solution containing zinc cation, the pH of the aqueous solution containing zinc cation being adjusted; and mixing the solutions and thereby producing metal complex nanoparticles composed of the metal atom M_{A} and zinc under controlling the properties of the obtained metal complex nanoparticles.

(2) The method for producing metal complex nanoparticles according to item (1), wherein the particle size of the metal complex nanoparticles produced is minimized by adjusting the pH of the aqueous solution containing zinc cation to the range of 1 to 4.

(3) The method for producing metal complex nanoparticles according to item (1), wherein the pH of the aqueous solution containing zinc cation is adjusted to the range of 1 to 6.

(4) The method for producing metal complex nanoparticles according to any one of items (1), wherein the metal atom M_{A} is one kind or two or more kinds of metal atoms selected from the group consisting of vanadium, chromium, molybdenum, tungsten, manganese, iron, ruthenium, cobalt, nickel, platinum, and copper.

(5) The method for producing metal complex nanoparticles according to any one of items (1), wherein after the metal complex nanoparticles are produced, the metal complex nanoparticles are treated with an aqueous solution containing a metal cyano complex anion which has the following metal atom M_{C} as a central metal, and/or with an aqueous solution containing a cation of the following metal atom M_{D}.

[Metal atom M_{C}: at least one metal atom, or two or more metal atoms, selected from the group consisting of vanadium, chromium, molybdenum, tungsten, manganese, iron, ruthenium, cobalt, nickel, platinum, and copper.]
[Metal atom M_{D}: at least one metal atom, or two or more metal atoms, selected from the group consisting of vanadium, chromium, manganese, iron, ruthenium, cobalt, rhodium, nickel, palladium, platinum, copper, silver, zinc, lanthanum, europium, gadolinium, lutetium, barium, strontium, and calcium.]

(6) The method for producing metal complex nanoparticles according to any one of items (1), wherein the metal complex nanoparticles have an average particle size of 200 nm or less.

(7) Metal complex nanoparticles produced by the method according to any one of items (1), the metal complex nanoparticles comprising: a metal atom M_{A} and zinc formed in a Prussian blue-like crystal structure, the nanoparticles having an average particle size of 200 nm or less.

(8) The metal complex nanoparticles according to item (7), wherein a metal cyano complex anion and/or a metal cation is adsorbed on the surface of the Prussian blue-like crystal composed of the metal atom M_{A} and zinc.

(9) The metal complex nanoparticles according to item (8), wherein the Prussian blue-like crystal is formed in a core, and a shell formed by a combination of the anion and the cation adsorbed on the core is formed in which the shell has a Prussian blue type metal complex structure made of a metal composition different from the metal composition of the core.

### EFFECTS OF THE INVENTION

According to the production method of the present invention, in connection with nanoparticles of a metal complex containing zinc formed in a particular crystal structure, high productivity can be attained, and the desired properties can be provided to the nanoparticles. The metal complex nanoparticles which are obtained by the production method described above and imparted with desired properties, can exhibit preferable performance as an electrochemically responsive material. Thus, the metal complex nanoparticles make the variation of materials of this type richer, and also contribute to expansion of the style or function of the applications.

Other and further features and advantages of the invention will appear more fully from the following description, appropriately referring to the accompanying drawings.

### BRIEF DESCRIPTION OF THE DRAWINGS

FIG. 1 is a cross-sectional diagram schematically illustrating an electrode utilizing a zinc-iron cyano complex as a preferred embodiment of the present invention.

FIG. 2 is a cross-sectional diagram schematically illustrating a transmitted light regulator utilizing a zinc-iron cyano complex as a preferred embodiment of the present invention.

FIG. 3 (a), (b), and (c) is a drawing-substituting photograph obtained by picking up an image of a zinc-iron cyano complex sample prepared in the Example using a scanning electron microscope.

FIG. 4 is a graph illustrating the results of the measurement of a zinc-iron cyano complex prepared in the Example according to a cyclic voltammetry.

FIG. 5 is a graph illustrating the coloration efficiency spectrum of zinc-iron cyano complex nanoparticle thin film prepared in the Example.

FIG. 6 is an explanatory view schematically illustrating the crystalline structure of Prussian blue-type metal complex.

FIG. 7 is an explanatory view schematically illustrating the crystal structure of a zinc-iron cyano complex (Prussian blue-like metal complex) (cited from the aforementioned Non-Patent Literature 1).

### DESCRIPTION OF THE PREFERRED EMBODIMENTS

The production method of the present invention is a method of mixing an aqueous solution containing a metal cyano complex anion which has a metal atom M_{A} as a central metal, and an aqueous solution containing zinc cation. Consequently, nanoparticles of a metal complex composed of the metal atom M_{A} and zinc can be produced. In the method, the pH of the aqueous solution containing zinc cation is significantly adjusted. Thereby, it is made possible to control the properties such as the electrochemical responsiveness and particle size of the metal complex nanoparticles thus produced (in the present specification, the properties of the particles are said to include information on the particle size). The reasons for obtaining such effects are not clearly known in some aspects, but it is known that zinc ion precipitates as zinc hydroxide in a weakly basic aqueous solution. That is, zinc ion tends to be more evenly dispersed in an aqueous solution in an acidic state, compared the one in a neutral state or a weakly acidic state. By using such a behavior, it is believed that variety to the dispersed state of zinc ion may be given by adjusting the pH of the raw material liquid, and hence controllability is imparted to the properties of the produced complex particles. Hereinafter, the present invention will be described in detail based on a preferred embodiment.

The zinc-iron cyano complex obtained by the production method of the present embodiment is such that the main composition formula can be represented by the following formula (A). This complex does not have a Prussian blue type structure but has the Prussian blue-like crystal structure described above.

AₓZn[Fe(CN)₆]_{y}.zH₂O (A)

It is an atom derived from A. x is a number from 0 to 2. y is a number from 1 to 0.3. z is a number from 0 to 20.

### [Crystal Precipitation]

First, a process for precipitating the crystals of the zinc-iron cyano complex of the above-mentioned embodiment will be explained. The specific production method includes mixing an aqueous solution containing a metal cyano complex anion having iron as a central metal with an aqueous solution containing zinc cation, and precipitating the crystals of a cyano complex having zinc and iron.

### (Iron Cyano Complex)

There are no particular limitations on the counter ion of the iron cyano complex anion, but examples include potassium ion, ammonium ion, and sodium ion. In the formula (A), the iron atom moiety can be substituted with other metals, and accordingly, the constituent central metal of the metal cyano complex anion used as the raw material may be a metal other than iron (Fe). For example, the metal atom M_{A} (including iron) may be one kind or two or more kinds of metal atoms selected from the group consisting of vanadium, chromium, molybdenum, tungsten, manganese, iron, ruthenium, cobalt, nickel, platinum, and copper. Among them, iron or chromium is preferred. There are no particular limitations on the concentration of the iron cyano complex or the complex having a metal atom M_{A} in an aqueous solution, but the concentration is preferably 1% to 30% by mass, and more preferably 2% to 10% by mass. When the concentration is adjusted to such a range, metal complex nanoparticles can be produced in the system at a concentration appropriate for industrial use.

### (Zinc Ion)

The raw material of supplying zinc ion used in the present embodiment is preferably a zinc compound (a salt of zinc ion). There are no particular limitations on the counter ion of the zinc ion, but examples include Cl⁻, NO₃⁻, and SO₄²⁻. There are no particular limitations on the concentration of the zinc compound in the aqueous solution, but the concentration is preferably 1% to 20% by mass, and more preferably 2% to 10% by mass. When the concentration is adjusted to such a range, metal complex nanoparticles can be produced in the system at a concentration appropriate for industrial use.

There are no particular limitations on the mixing ratio of zinc ion and the iron cyano complex ion, but it is preferable to mix the ions such that the ratio “Zn:Fe” is 3:1 to 1:1 at a molar ratio.

The iron cyano complex does not necessarily need to contain the cation A of the formula (A). When the complex contains the cation A, examples of the cation A include, but are not limited to, potassium, sodium, cesium, rubidium, hydrogen, and ammonia. The complex may also contain other materials such as an anion. The complex also does not necessarily need to contain water (H₂O).

### (Adjustment of pH)

In the production method of the present embodiment, the size of the crystals of the zinc-iron cyano metal complex obtained herein largely affects the particle size of the nanoparticles that are finally obtained. Accordingly, in order to control the size of this Prussian blue-like metal complex, the particle size of the nanoparticles that are finally obtained can be controlled by adjusting the pH of the zinc ion solution. Specifically, it is preferable to adjust the pH of the zinc ion aqueous solution to be acidic, and it is preferable to adjust the pH to the range of 1 to 6. Specifically, there may be mentioned an embodiment in which the pH is controlled to be in the acidic region of 1 to 4 (preferably, around pH 2) so as to minimize the size of the produced nanoparticles. There are no particular limitations on the control range of the produced nanoparticles, but particles having a size as desired can be synthesized by controlling the size to the range of 10 nm to 500 nm and can be supplied. Furthermore, an important advantage of the present embodiment is that not only the control of particle size, but also the control of dispersibility as well as the control of electrochemical responsiveness are also made possible. The controllability may not be consistent all the time, but for example, an electrochemically responsive material (active material) which responds more sensitively can be produced by adjusting the pH of the zinc ion solution to 1 to 3.

There are no particular limitations on the method of adjusting the pH of the zinc ion solution. However, since the pH of the solution is usually near neutrality when only a zinc compound is dissolved, there may be mentioned an embodiment in which the zinc ion solution is made acidic by adding an acidic compound. Any acidic compound may be used for this purpose, and examples include hydrochloric acid, sulfuric acid, nitric acid, and organic acids such as acetic acid.

When the metal complex nanoparticles obtained in the present embodiment are used, the metal complex nanoparticles may be in mixture with other complexes as long as a half or more of the nanoparticles maintain a structure represented by the composition formula (A) shown above. For example, a metal ion, an organic molecule, a metal complex and the like may be adsorbed to the nanoparticles in order to enhance optical responsiveness, catalyst activity, dispersibility, adsorbability to a metal layer, and the like, and even in such cases, it is desirable if the main structure has the composition formula shown above. Furthermore, in the case of producing an electrochemical element, only the metal complex nanoparticles may constitute the electrochemically responsive layer (active material layer), or a combination of the metal complex nanoparticles and other functional materials may constitute the layer. Examples of the materials that can be combined with the nanoparticles and applied to the electrochemically responsive layer, include carbon materials such as acetylene black; various nanoparticles of ITO, gold, platinum and the like; and electroconductive polymers. The use of the metal complex nanoparticles in combination with an electroconductive polymer such as PEDOT or PSS is not to be obstructed. Furthermore, in regard to the order of synthesis of the metal complex nanoparticles described above, reference can be made to the stirring extraction method described in PCT International Patent Application WO 2006/087950 pamphlet, which though relates to a Prussian blue type metal complex.

### [Superficial Modification (1)]

In the present embodiment, it is preferable to mix zinc-iron cyano complex crystals obtained as described above, with an aqueous solution containing a metal cyano complex anion which has a metal atom M_{C} as a central metal, and/or an aqueous solution containing a cation of a metal atom M_{D}, and to thereby obtain surface-modified zinc-iron cyano complex nanoparticles. Thereby, the particle surfaces can be charged to a desired state, and for example, dispersibility in an aqueous medium can be imparted to the microparticles. In regard to the principles of such solubilization or dispersibilization, reference can be made to the description in paragraphs [0023] to [0025] of WO 2008/081923 pamphlet.

Here, the nature of general particles will be described. Even in the case where primary particles are nanometer-size particles, when the particles physically aggregate in a solvent so as to be excessively large, the particles are eventually identical to bulk particles. As a result, the particles become insoluble (hardly soluble), or unable to disperse (hard to disperse), in the solvent. (In the present invention, such state is referred to as “substantially insoluble”. To be specific, it is preferred that the following state can be maintained for 30 minutes or longer. The state is at the concentration of being dissolved or dispersed particles kept in 1 mass % or more at room temperature (25° C.). Accordingly, a Prussian blue-type metal complex obtained by a general production method is substantially insoluble in a solvent such as water.

In contrast, according to the production method of the present invention, a Prussian blue-like metal complex having an extremely small size of, for example, about 10 to 500 nm can be obtained. In addition, individual nanoparticles can be made soluble or dispersible in various solvents by bringing each of their crystal surfaces into a predetermined charged state to maintain a state where the nanoparticles are separated from each other. The term “soluble or dispersible” as used in the present invention refers to a state different from the above “substantially insoluble” state. To be specific, it is preferred that the following state can be maintained for 30 minutes or longer. The state is at the concentration of being dissolved or dispersed particles kept in the range of 5 to 100 mass % at room temperature (25° C.). It is more preferred that the following state can be maintained for one day or longer at the concentration kept in the range of 10 to 100 mass %. It should be noted that the above-mentioned surface of each fine particle may be “positively” charged, or may be “negatively” charged.

To be more specific, an electrostatic repulsive interaction is caused to act between the nanoparticles to prevent the aggregation of the nanoparticles in a solvent. As a result, the nanoparticles can be dispersed in the solvent. Water is particularly preferably utilized as the solvent because water molecules each have polarity. When the nanoparticles are turned into fine particles soluble or dispersible in water (water-dispersible fine particles) as described above, the fine particles can be dissolved or dispersed in, for example, an aqueous medium (such as water, a mixed liquid of water and an alcohol, or an aqueous solution of an inorganic salt such as hydrochloric acid or an aqueous solution of sodium hydroxide) or a polar solvent such as an alcohol.

### (Metal Atom M_{C})

Here, metal atom Mc is one kind or two or more kinds of metal atoms selected from the group consisting of vanadium, chromium, molybdenum, tungsten, manganese, iron, ruthenium, cobalt, nickel, platinum, and copper. The preferable range thereof and counter ions thereof are the same as those described in the iron cyano complex anion.

The cyano complex anion of metal atom M_{c} (similar to the above iron-cyano complex anion) is preferably a hexacyano metal complex anion. In ordinary cases, the hexacyano metal complex anion is of such a shape that a metal atom is surrounded with six cyano groups; a part of the cyano groups may be substituted by other molecules, and the number of cyano groups may range from two to eight.

### (Metal Atom M_{D})

Metal atom M_{D} is at least one metal atom, or two or more metal atoms, selected from the group consisting of vanadium, chromium, manganese, iron, ruthenium, cobalt, rhodium, nickel, palladium, platinum, copper, silver, zinc, lanthanum, europium, gadolinium, lutetium, barium, strontium, and calcium. The preferable range and counter ions are similar to the ones explained as to zinc ion.

Although the addition amounts of the metal atoms M_{C} and M_{D} to be added at one time are not particularly limited, for example, a molar ratio “the total number of moles of the metal atoms M_{A} and zinc”:“the number of moles of the metal atom M_{C} or M_{D}” is set to fall within the range of preferably 1:0.01 to 1:0.5, or more preferably 1:0.05 to 1:0.2. Changing the addition amounts can adjust the amount of the shell portion with which the core portion is coated, thereby enabling the regulation of the color property, electrochemical responsiveness, dispersion property, and the like of nanoparticles to be obtained. In addition, dispersion selectivity can be imparted to each nanoparticle. In this case, the shell portion is not requested to coat the entire outer surface of the core portion completely, and may be unevenly distributed to part of the outer surface of the core portion. When the state where the shell portion is unevenly distributed and the amount of the shell portion described above are adjusted, a nanoparticle with its color property finely regulated by a combination of the color of the core portion and the color of the shell portion can be obtained.

### [Superficial Modification (2)]

As another embodiment of the production method of the present invention, there may be mentioned an embodiment in which an organic ligand L is added to the nanoparticles of the zinc-iron metal cyano complex described above. Thereby, the nanoparticles can be made into nanoparticles having satisfactory dissolvability or dispersibility in an organic solvent. As the organic ligand, it is preferable to use one kind or two or more kinds of a compound having a pyridyl group or an amino group as a binding site to the particles (preferably a compound having from 3 to 100 carbon atoms, and more preferably a compound having from 3 to 16 carbon atoms), and it is more preferable to use one kind or two or more kinds of a compound represented by any one of the following formulae (1) to (3).

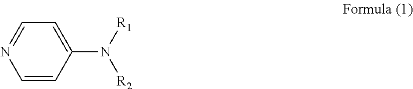

In formula (1), R₁ and R₂ each independently represents a hydrogen atom, or an alkyl group, alkenyl group or alkynyl group, each having 3 or more carbon atoms (preferably having 3 to 18 carbon atoms). R₁ and R₂ are preferably an alkenyl group, in which there is no upper limit on the number of carbon-carbon double bonds therein, it is preferable that the number is 2 or less. When the ligand L having an alkenyl group is used, the dispersibility can be improved even when the compound is hard to disperse in a solvent other than a polar solvent (excluding methanol and acetone from which a ligand may be left by desorption, e.g., chloroform). Specifically, using a ligand having an alkenyl group, the resultant compound can favorably disperse in a nonpolar solvent (e.g., hexane), unless the ligand is eliminated. This is the same as in the cases of R₃ and R₄. Among the compounds represented by formula (1), 4-di-octadecylaminopyridine, 4-octadecylaminopyridine, and the like are preferable.

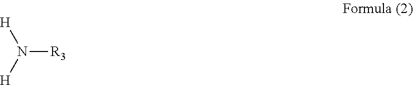

In formula (2), R₃ represents an alkyl group, alkenyl group or alkynyl group, each having 3 or more carbon atoms (preferably having 3 to 18 carbon atoms). R₃ is preferably an alkenyl group. Although there is no upper limit on the number of carbon-carbon double bonds, it is preferable that the number is 2 or less. Among the compounds represented by formula (2), oleylamine is preferable as a ligand having an alkenyl group, and stearylamine is preferable as a ligand having an alkyl group.

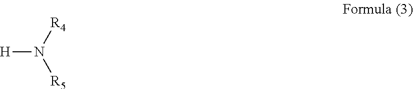

In formula (3), R₄ represents an alkyl group, alkenyl group or alkynyl group, each having 3 or more carbon atoms (preferably having 3 to 18 carbon atoms), and R₅ represents an alkyl group, an alkenyl group, or an alkynyl group (each preferably having 1 to 60 carbon atoms). It is preferable that R₄ be an alkenyl group. There is no upper limit on the number of carbon-carbon double bonds, and it is preferable that the number be 2 or lower.

Meanwhile, the compounds represented by formula (1) to (3) may have a substituent, unless the effects of this invention are obstructed.

The coordination amount of the ligand L in each Prussian blue-like metal complex nanoparticle is not particularly limited, and, for example, a molar ratio of the ligand to the metal atoms in the nanoparticle (the total amount of the metal atoms, zinc, iron, M_{C}, and M_{D}) is preferably set to about 5 to 30%, though the preferable value varies depending on the particle size and shape of each ultrafine particle. With such setting, a stable dispersion (ink) containing the nanoparticles of the Prussian blue-like metal complex can be prepared, and an ultrafine particle thin-film layer can be produced by film formation from a liquid with high accuracy. The addition amount of the ligand L at the time of the preparation of the dispersion is preferably as follows: a molar ratio of the ligand to the metal ions in each nanoparticle (the total amount of zinc, iron, the metal atoms M_{C}, and M_{D}) is about 1:0.2 to 1:2.

When the Prussian blue-like metal complex nanoparticles are each caused to adsorb the ligand L, the nanoparticles can be turned into fine particles that can be dissolved or dispersed in an organic solvent. Examples of the organic solvent include toluene, dichloromethane, chloroform, hexane, ether, and butyl acetate. That is, the dispersion property of each of the Prussian blue-like metal complex nanoparticles can be switched by using the ligand L. The amount of the Prussian blue-like metal complex nanoparticles, which are made organic solvent-dispersible, to be dissolved or dispersed in the organic solvent is not particularly limited; the amount is preferably 5 to 100 mass %, or more preferably 10 to 100 mass %.

### [Nanoparticle]

The term “nanoparticles” as used in the present invention refers to particles which are fined to have sizes of the order of nanometer, and which can be dispersed in, and isolated from and re-dispersed in, various solvents in a nanoparticle state, i.e., which are discrete particles (particles that cannot be isolated from a dispersoid or dispersion and particles that cannot be isolated from and re-dispersed in the dispersoid or dispersion are not included in the category of the “nanoparticles”). The nanoparticles have an average particle size of preferably 500 nm or less, more preferably 200 nm or less, more preferably 100 nm or less, or specifically more preferably 50 nm or less. There is no particular limitation on the lower limit, but it is practical to employ an average particle size of 10 nm or more.

The term “particle size” as used in the present invention refers to the diameter of a primary particle free of any such protecting ligand as described later unless otherwise stated; the term refers to the circle-equivalent diameter of the particle (value calculated from the image of each ultrafine particle obtained by observation with an electron microscope as the diameter of a circle equivalent to the projected area of the particle). The term “average particle size” refers to the average of the particle sizes of at least 30 ultrafine particles measured as described above unless otherwise stated. Alternatively, the average particle size may be estimated from an average size calculated from the half width of a signal obtained by the powder X-ray diffraction (XRD) measurement of an ultrafine particle powder, or may be estimated from dynamic light scattering measurement; provided that, when the average particle size is measured by the dynamic light scattering measurement. In this regards, attention must be paid to the fact that the resultant particle size may be obtained as that including a protecting ligand. Furthermore, in the case of cuboidal particles, the average of the particle sizes in three directions is designated as the average particle size.

It should be noted that, in a state where the nanoparticles are dispersed in a solvent, two or more of the nanoparticles collectively behave as a secondary particle, and an additionally large average particle size may be observed depending on a method for the measurement of the average particle size and the environment thereof; when the ultrafine particles in a dispersed state serve as secondary particles, the average particle size of the secondary particles is preferably 500 nm or less. It should be noted that an additionally large aggregate may be formed by, for example, the removal of a protecting ligand as a result of, for example, a treatment after the formation of an ultrafine particle film, and the present invention should not be construed as being limitative owing to the formation of the aggregate.

### [Dispersion]

In the production method of the present invention, the Prussian blue-like metal complex nanoparticles are obtained in a state of being dissolved or dispersed in a mixed liquid; a fine particle powder can be obtained by separating the solvent through, for example, removal by distillation under reduced pressure, filtration, or centrifugal separation.

The dispersion of the nanoparticles can be processed by using various kinds of film-forming technologies and printing technologies. As the printing technologies, an inkjet printing method, a screen printing method, a gravure printing method, a relief-printing method, and the like can be used. As the film-forming technologies, a spin coating method, a bar coating method, a squeegee method, Langmuir-Blodgett method, a casting method, a spraying method, a dip coating method, and the like can be used. Alternatively, a method involving the use of a chemical bond between a substrate and each nanoparticle is also permitted. Those methods allow one to utilize the dispersion in the processing of, for example, various devices.

In this case, nanoparticle dispersion is preferably used, and a solvent for the dispersion may be water, methanol, ethylene glycol, or the like, or may be a mixed liquid of them. In addition, another substance such as a resin may be mixed into the dispersion for adjusting various properties of the dispersion such as a viscosity and a surface tension.

### [Various Elements and Devices]

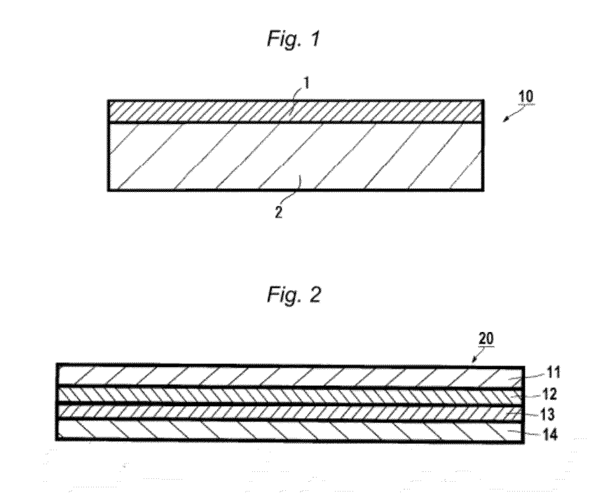

An electrode can be obtained by using the Prussian blue-like metal complex nanoparticles of the present invention. For example, when the nanoparticles are utilized in an electrode for an electrochemical device, the upper portion of a conductor is preferably caused to adsorb the nanoparticles by employing any one of the above application techniques. FIG. 1 is a sectional view schematically showing a preferred embodiment of an electrode of the present invention. For example, a flat electrode is obtained by providing a layer 1 composed of the nanoparticles of the present invention on a flat conductor 2. The flat conductor 2 may be composed of one layer or multiple layers, or may be a combination of an insulator and a conductor.

The shape of the electrode 10 of the present invention is preferably, for example, a rectangular shape, a circular shape, or a rod shape, but is not limited to them. The thickness, shape, and the like of the flat conductor 2 are not requested to be identical to those of the nanoparticle layer 1. In addition, the nanoparticle layer 1 may be a mixed film containing the nanoparticles and another material or containing multiple kinds of nanoparticles, or may be a multilayer film for the purpose of, for example, improving the electric conductivity or electrochemical responsiveness.

The electrode as described above is characterized by having less change in the color accompanying an electrochemical reaction, and being close to transparency irrespective of the oxidation state. These characteristics exhibit those effects when the electrode is combined with a material capable of changing color by another electrochemical reaction in a transmitted light regulator.

FIG. 2 shows the structure of a representative transmitted light regulator 20. The structure includes, from both ends, a transparent insulating layer 11, a transparent conductive layer 12, an electrochemically responsive layer 13, and an electrolyte layer 14, and when the zinc-iron cyano complex nanoparticles obtained by the present invention are used on one side of this electrochemically responsive layer, the color change of the other side of the electrochemically responsive layer is directly linked to the color of the element per se. Thus, design of the element is made easier. Particularly, when identical elements are superimposed and used together, an enhancement of transparency can be expected by using the material of the present invention. However, the present invention is not intended to be limited to this. For example, the electrolyte layer may be omitted. Furthermore, in the case of regulating reflected light instead of transmitted light, one of the transparent conductive layer and the transparent insulating layer may be non-transparent.

A material for the transparent insulating layer is not particularly limited as long as the material is transparent and has insulating property; for example, glass, quartz, or a transparent insulating polymer (such as polyethylene terephthalate or polycarbonate) can be utilized.

A material for the transparent conductive layer is not particularly limited as long as the material is transparent and conductive; for example, indium tin oxide (ITO), tin oxide, zinc oxide, cadmium tin oxide, or any other transparent substance showing metallic conductivity can be utilized. Furthermore, in the case of a reflected light regulator, since there is no need for the conductive layer to be transparent, any material that does not corrode within the element can be used. For example, stainless steel, gold, platinum and the like can be used.

The electrochemically responsive layer may be any material having electrochemical responsiveness, such as a layer formed from a dispersion liquid containing Prussian blue metal complex nanoparticles; an electroconductive polymer layer formed of PEDOT:PSS or the like; titanium oxide doped with molecules of viologen or the like; or tungsten oxide.

The electrolyte layer 14 has only to satisfy the following conditions: the electrolyte layer is composed of a solid or liquid containing an electrolyte, and the reversibly color changeable thin-film layer (electrochemically responsive layer) 13 is not eluted in the electrolyte layer. To be specific, the electrolyte is preferably, for example, potassium hydrogen phthalate, potassium chloride, KPF₆, sodium perchlorate, lithium perchlorate, potassium perchlorate, or tetrabutyl ammonium perchlorate, or particularly preferably potassium hydrogen phthalate, KPF₆, or potassium perchlorate. When an electrolyte solution prepared by dissolving the electrolyte in a solvent is used in the electrolyte layer, water, acetonitrile, propylene carbonate, ethylene glycol, or the like is preferably used as the solvent. Alternatively, any one of the various polymer solid electrolytes, superionic conductors, and the like can also be used. An electrochemical-property-regulating agent, color-property-regulating agent, or the like to be described later may be incorporated into the electrolyte layer 4. The electrolyte layer 4 may contain a solid for regulating the optical property, electrochemical property, and the like of the apparatus. Furthermore, the electrolyte layer may contain a solid so as to control the optical characteristics, electrochemical characteristics and the like, and the electrolyte layer may be omitted if the element has sufficient electrochemical responsiveness even without the electrolyte layer.

In addition, a sealing material can be provided as required, and an insulating material capable of preventing the drain of the electrolyte is preferably used as the sealing material. For example, any one of the various insulating plastics, glass, ceramic, an oxide, or rubber can be used.

The transmitted light-regulator of the present invention can be molded into a shape in accordance with a purpose. In addition, the respective layers of the apparatus are not requested to have the same shape. The size of the apparatus is not particularly limited, and, when the apparatus is used as a device for large-screen display, its area can be set to fall within the range of, for example, 1 to 3 m²; on the other hand, when the apparatus is produced as an ultrafine pixel for color display, the area is preferably set to fall within the range of, for example, 1.0×10⁻¹⁰ to 1.0×10⁻¹ m², or is preferably set to about 1.0×10⁻⁸ m².

Further, for example, when a figure, letter pattern, or the like having a desired shape is displayed, a color display region may be designed by providing the reversibly color changeable thin-film layer 13 with a desired shape. Further, while the reversibly color changeable thin-film layer 13 itself is wirdely provided, the color display region may be designed by providing the conductive structure layer under it. It should be noted that the transmitted light-regulator of the present invention may be as follows: the apparatus can achieve not only the reversibly color changeable display of a figure or letter pattern, but also a free change of, for example, the color of a wall surface in a habitable room or shop, or the surface color of a piece of furniture by the change of the coloring of the entire apparatus, and adjusts and regulates the color pattern of the wall surface and/or the color pattern of the piece of furniture. In addition, when a transparent material is used in the counter conductive structure layer (to be specific, any one of the materials for the transparent conductive film and the transparent insulating layer described above can be used), the apparatus can be a reversibly color changeable dimming apparatus. The use of the apparatus enables, for example, the control of the state of window glass or the like between a colored state and a transparent state.

In addition, an additionally specific application example is as follows: a segment-type display such as a commodity price display in a supermarket can be produced by, for example, combining a large number of transmitted light-regulators. Upon formation of a device including a large number of pixels in, for example, an electronic paper application, a product in which devices each composed of the transmitted light-regulator are arrayed in an array fashion is preferably formed. An ordinary regulate method such as a passive matrix mode or an active matrix mode can be employed in display regulate in this case. In addition, when various patterns are formed by employing a printing technique, and are placed on the surfaces of artifacts such as a piece of furniture, a building, and a car body, the external appearance of an artifact on which a pattern has been placed can be changed by performing regulate as to whether or not the pattern is displayed.

Particularly, the zinc-iron cyano complex according to a preferred embodiment of the present invention can be imparted with image recording property, that is, a property by which color is changed when voltage is applied, and the color development state is maintained even after the application of voltage is terminated. Therefore, the zinc-iron cyano complex can be used as a display device which does not require electric power consumption while performing a desired display, and contributes to energy saving to a great extent as compared with, for example, liquid crystal display devices.

Furthermore, since the zinc-iron cyano complex according to the present invention exhibits stable electrochemical characteristics, the zinc-iron cyano complex can also be used as an electrode material for batteries, capacitors and the like. In this case, use can be made by directly applying the nanoparticles on an electrode, or the nanoparticles can also be mixed with a binder, an auxiliary conductive agent or the like.

The zinc-iron cyano complex according to a preferred embodiment of the present invention does not require complicated processes and does not need to bring the solution of the raw material used to a low concentration, and the nanoparticles thus obtained are dispersed in water. Therefore, the zinc-iron cyano complex can be subjected to film forming and microprocessing through coating, printing or the like, and the film that is obtained therefrom exhibits stable electrochemical responsiveness without addition of any other material.

### EXAMPLES

The present invention will be described in more detail based on examples given below, but the invention is not meant to be limited by these.

### Example 1

Zinc-iron cyano complex nanoparticles were prepared as described below. To a solution prepared by dissolving 1.09 g of zinc chloride in 20 mL of water, a small amount of hydrochloric acid was added, and an aqueous solution having the pH adjusted to 1.9. Further, a solution was prepared by dissolving 1.94 g of sodium ferrocyanide in 20 mL of water. This solution was mixed with the aforementioned solution all at once. The resulting mixture was stirred for 3 minutes. A precipitate of the zinc-iron Prussian blue-like complex thus precipitated was separated by centrifugation, and the precipitate was washed five times with water. To the precipitate thus obtained, a solution prepared by dissolving 0.581 g (10% of the total amount of metal) of sodium ferrocyanide decahydrate in 10 mL of water was added. The concentration of the mixture was adjusted to 0.05 g/ml, and this suspension was stirred for 7 days, which then turned into a white dispersion liquid. As such, a nanoparticles dispersion liquid of water-dispersible zinc-iron Prussian blue-like complex L2 was obtained (the average particle size was about 100 nm).

In the preparation method described above, the content of hydrochloric acid was regulated so as to adjust the pH of the aqueous solution of zinc oxide to 5.0, or to adjust the aqueous solution of zinc oxide to 1 Normal, and thereby zinc-iron cyano complex nanoparticles dispersion liquids L1 and L3 were obtained respectively.

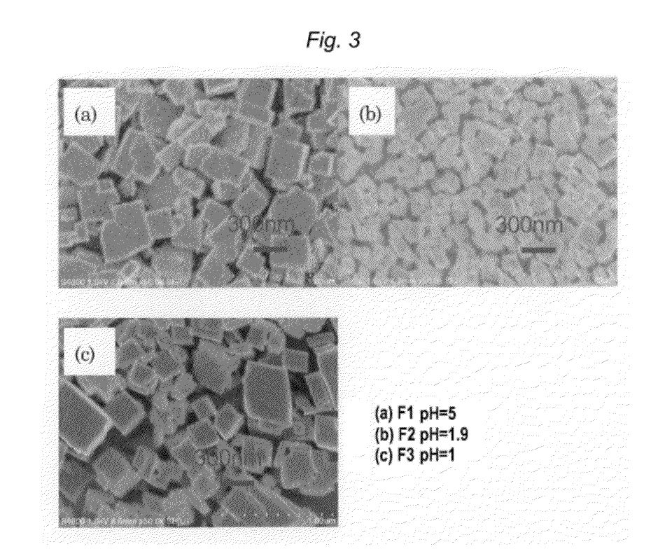

These nanoparticle dispersion liquids L1 to L3 were respectively applied on ITO glass substrates by a spin coating method, and thus zinc-iron complex nanoparticle thin films F1, F2 and F3 were obtained. Scanning electron microscopic images of these thin films are presented in FIG. 3. It was found that the particles were all nanoparticles having a particle size of 500 nm or less. Particularly, in the case of pH=1.9, it was found that the nanoparticles had a particle size of about 100 nm and were smaller even when compared with others.

### (Evaluation of Electrochemical Responsiveness)

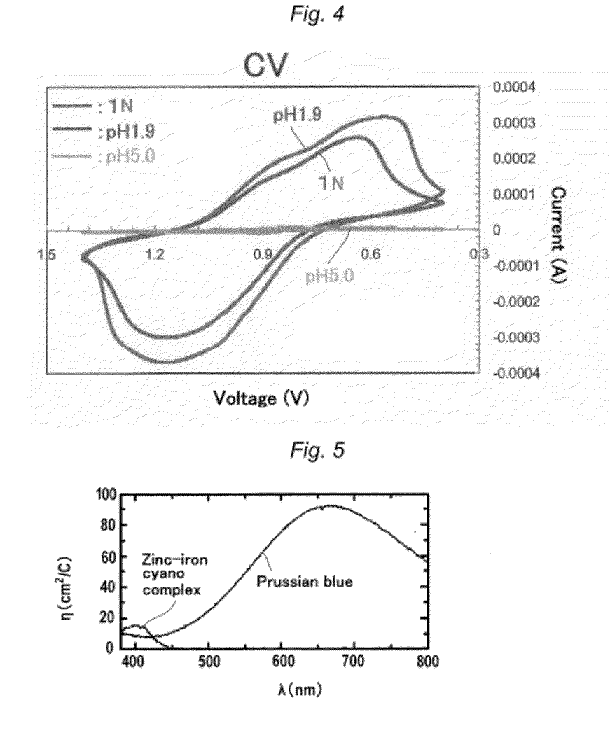

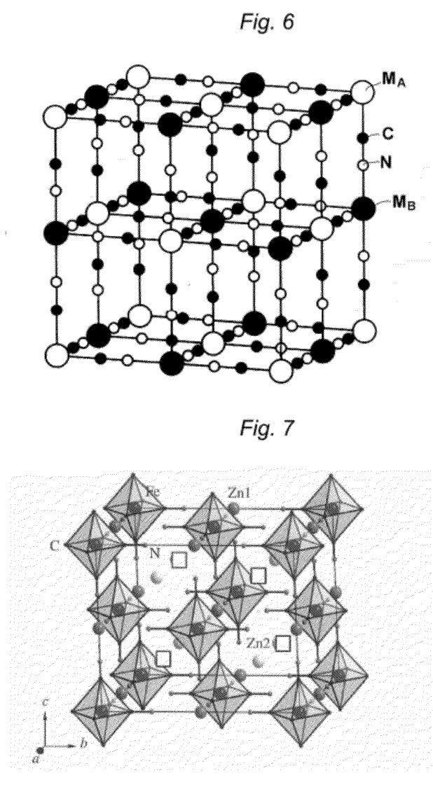

The electrochemical characteristics of the thin films F1, F2 and F3 obtained as described above were evaluated by a cyclic voltammetry. The cyclic current-potential curve thus obtained is presented in FIG. 4. Each of the electrodes was used as a working electrode, and a platinum wire was used as a counter electrode, while a saturated calomel electrode was used as a reference electrode. A 0.1 M propylene carbonate solution of potassium bis(trifluoromethanesulfonyl)imide was used as an electrolyte solution. The scan rate was 5 mV/s.

In conclusion, electrochemical responsiveness was not observed in the thin film F1 at pH=5.0. This is believed to be because the electrochemical characteristics disappeared due to peeling or the like. Particularly, in the case of the thin film F2 at pH=1.9, sufficiently stable electrochemical characteristics were observed. From these results, it is understood that nanoparticles having high electrochemical stability are obtained by regulating the pH during the preparation of nanoparticles and thereby controlling the particle size to be small.

### (Evaluation of Coloration Efficiency)

The coloration efficiency was calculated from the transmittance obtained at the time of this electrochemical reaction. The coloration efficiency is defined as an area in which 1 Coulomb of electrical charge can cause a unit change in the absorbance that accompanies electrochemical responsiveness, and specifically, the coloration efficiency is calculated by the following expression.

η(λ)=(log₁₀(T_{B}(λ)/T_{C}(λ))/Q_{C} (B)

Here, η(λ) represents the coloration efficiency for each wavelength; T_{B}(λ) and T_{C}(λ) represent the transmission spectra at the time of coloration and decoloration; and Q_{C} represents the amount of electric charge required in coloration.

FIG. 5 shows a coloration efficiency spectrum of a zinc-iron cyano complex nanoparticle thin film. As a comparison, the same spectrum of an iron-iron cyano complex nanoparticle thin film is also presented. The method for preparing the iron-iron cyano complex nanoparticles was carried out according to the description in paragraph [0058] to [0060] of WO 2006/087950 pamphlet. As such, the zinc-iron cyano complex nanoparticles have very low coloration efficiency, and use thereof in the counter electrode of a color-changing element as described above can be expected.

### INDUSTRIAL APPLICABILITY

According to the production method of the present invention, zinc-iron cyano complex nanoparticles can be obtained as a transparent material having stable electrochemical characteristics, with a very small color change in such electrochemical action. From this viewpoint, it is expected that the material can be applied to color changeable apparatuses such as dimming glass and electronic paper; electric energy storage devices such as secondary batteries and capacitors; separation and collection of ions and the like; and uses in ion sensors, biosensors and the like.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-217848 filed in Japan on Sep. 28, 2010, which is entirely herein incorporated by reference.

1. A method for producing metal complex nanoparticles, the method comprising:
providing an aqueous solution containing a metal cyano complex anion having a metal atom M_{A} as a central metal, with an aqueous solution containing zinc cation, the pH of the aqueous solution containing zinc cation being adjusted; and
mixing the solutions and thereby producing metal complex nanoparticles composed of the metal atom M_{A} and zinc under controlling the properties of the obtained metal complex nanoparticles.

2. The method for producing metal complex nanoparticles according to claim 1, wherein the particle size of the metal complex nanoparticles produced is minimized by adjusting the pH of the aqueous solution containing zinc cation to the range of 1 to 4.

3. The method for producing metal complex nanoparticles according to claim 1, wherein the pH of the aqueous solution containing zinc cation is adjusted to the range of 1 to 6.

4. The method for producing metal complex nanoparticles according to claim 1, wherein the metal atom M_{A} is one kind or two or more kinds of metal atoms selected from the group consisting of vanadium, chromium, molybdenum, tungsten, manganese, iron, ruthenium, cobalt, nickel, platinum, and copper.

5. The method for producing metal complex nanoparticles according to claim 1, wherein after the metal complex nanoparticles are produced, the metal complex nanoparticles are treated with an aqueous solution containing a metal cyano complex anion which has the following metal atom M_{C} as a central metal, and/or with an aqueous solution containing a cation of the following metal atom M_{D}, wherein Metal atom M_{C} is at least one metal atom, or two or more metal atoms, selected from the group consisting of vanadium, chromium, molybdenum, tungsten, manganese, iron, ruthenium, cobalt, nickel, platinum, and copper, and wherein Metal atom Mₙ is at least one metal atom, or two or more metal atoms, selected from the group consisting of vanadium, chromium, manganese, iron, ruthenium, cobalt, rhodium, nickel, palladium, platinum, copper, silver, zinc, lanthanum, europium, gadolinium, lutetium, barium, strontium, and calcium.

6. The method for producing metal complex nanoparticles according to claim 1, wherein the metal complex nanoparticles have an average particle size of 200 nm or less.

7. Metal complex nanoparticles produced by the method according to claims 1 to 6, the metal complex nanoparticles comprising: a metal atom M_{A} and zinc formed in a Prussian blue-like crystal structure, the nanoparticles having an average particle size of 200 nm or less.

8. The metal complex nanoparticles according to claim 7, wherein a metal cyano complex anion and/or a metal cation is adsorbed on the surface of the Prussian blue-like crystal composed of the metal atom M_{A} and zinc.

9. The metal complex nanoparticles according to claim 8, wherein the Prussian blue-like crystal is formed in a core, and a shell formed by a combination of the anion and the cation adsorbed on the core is formed in which the shell has a Prussian blue type metal complex structure made of a metal composition different from the metal composition of the core.
